(19) United States
(12) Patent Application Publication
(10) Pub. No.: US 2013/0057042 A1
(43) Pub. Date: Mar. 7, 2013

(54) DAMPER FOR A VEHICLE SEAT

(71) Applicants: Carsten Kortwig, Ginsheim Gustavsburg (DE); Michael Dambacher, Ingolstadt (DE); Ralf Gutjahr, Nandlstadt (DE); Markus Spoetter, Graefelfing (DE)

(72) Inventors: Carsten Kortwig, Ginsheim Gustavsburg (DE); Michael Dambacher, Ingolstadt (DE); Ralf Gutjahr, Nandlstadt (DE); Markus Spoetter, Graefelfing (DE)

(73) Assignee: LEAR CORPORATION, Southfield, MI (US)

(21) Appl. No.: 13/588,883

(22) Filed: Aug. 17, 2012

(30) Foreign Application Priority Data
Sep. 6, 2011 (DE) 10 2011 082 147.3

(51) Int. Cl. B60N 2/30; B60N 2/20

(52) U.S. Cl. 297/378.1

(57) ABSTRACT

A recliner assembly for a vehicle seat having a seat back pivotally mounted relative to a seat bottom is provided. The seat back is movable between an upright position, where the seat back is in a generally vertical position for supporting an occupant seated on the seat, and a storage position, where the seat back is folded with respect to the seat bottom. The recliner assembly includes a damper operatively connected between the seat bottom and seat back. The damper includes an outer race and an inner race, wherein at least one of the inner race and outer race comprise an annular cam-profile surface. A plurality of rollers are disposed between the inner race and outer race, to cooperate with the cam-profile surface and the other one of the inner race and outer race to dampen movement of the seat back during at least partial movement from the upright position to the storage position.

### CROSS-REFERENCE TO RELATED APPLICATIONS

This application claims foreign priority benefits under 35 U.S.C. §119(a)-(d) to DE 10 2011 082 147.3, filed Sep. 6, 2011, the disclosure of which is hereby incorporated by reference in its entirety.

### TECHNICAL FIELD

Various embodiments relate to a damper for a vehicle seat recliner.

### BACKGROUND

A vehicle seat assembly may be provided with a reclining seat back having a damper for dampening pivotal movement of the seat back in at least one direction. One such example is disclosed in U.S. Pat. No. 7,344,195 issued to Folkert et al.

### BRIEF DESCRIPTION OF THE DRAWINGS

FIG. 1 illustrates a seat assembly according to an embodiment of the present disclosure;

FIG. 2 illustrates a side elevation view of the vehicle seat assembly of FIG. 1 where the vehicle seat assembly is folded;

FIG. 3 illustrates a section view of the recliner mechanism of vehicle seat assembly of FIG. 1 in an un-damped position;

FIG. 4 illustrates a section view of the recliner mechanism of vehicle seat assembly of FIG. 2 in a damped position; and

FIG. 5 illustrates a section view of the recliner mechanism of vehicle seat assembly taken through section A-A of FIG. 3;

### DETAILED DESCRIPTION

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Turning now to the figures, FIG. 1 illustrates a seat assembly 10 according to one embodiment of the present disclosure. Vehicles, such as automobiles and other passenger vehicles employ seats assemblies 10 in the passenger compartment of the vehicles. The seat assembly 10 generally includes a generally horizontal seat bottom 12 and a seat back 14 extending generally vertically upward from the seat bottom 12. The seat back 14 can also include a head restraint 16 which may be movably mounted on the seat back 14.

The seats are often positioned in rows. Some passenger vehicles, such as vans and sport utility-type vehicles, include multiple rows of seating within the interior of the vehicle. Often, these vehicles include a first or front row of seats for a driver and passenger, and one or more rows of rear seats behind the front row. In passenger vehicles with multiple rows of seat assemblies 10, the seat back 14 may be temporarily moved forward to create more cargo room in the interior of the vehicle or positioned to allow passenger ingress and egress. The seat back 14 is pivotally mounted on the seat bottom 12 by a recliner assembly 18 for pivoting the seat back 14 relative to the seat bottom 12.

In some embodiments, the seat backs 14 can be pivoted forwardly to a storage position so that the seat back 14 is folded completely forward to a generally horizontal position resting above the seat bottom 12. It is becoming increasingly more common in passenger vehicles, such as sport utility vehicles and mini-vans, to include three or more rows of seats. The third row seat is generally located at the furthest rear portion of the vehicle and is not located adjacent a door opening. Therefore, passengers do not have direct access to the third row seat. To provide access to the third row seat or a rear storage area, the second row seat assemblies 10 may be movable to a forwardly folded position adjacent the front row of seats. The second row seat assembly may be folded such that the seat back 14 is first folded downwardly on top of the seat bottom 12. The folded seat assembly 10 may then be pivoted about a pivot point at a lower front edge of the seat bottom 12. The seat back of the second row seat assembly 10 will then be positioned between the seat bottom 12 and the seat back of the front row seat. The passenger can then enter the vehicle via one of the rear doors, and slip past the folded second row seat assembly 10, thereby permitting access to the third row seat.

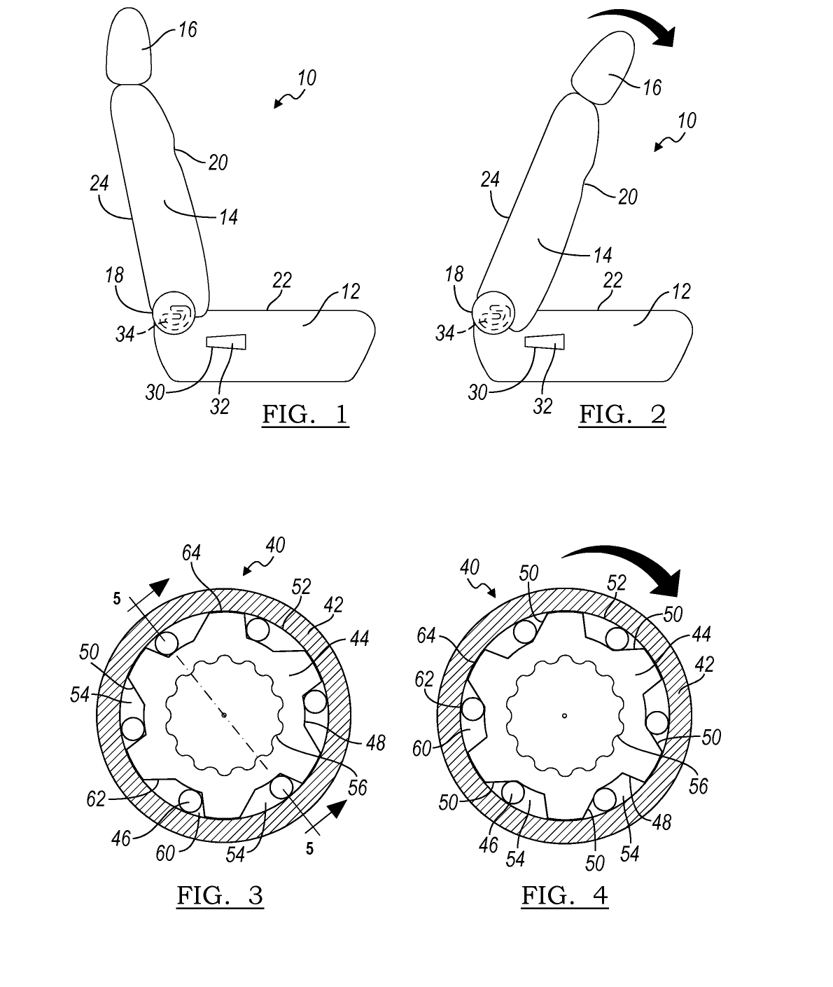

The recliner assembly 18 may be covered by a trim cover for aesthetic purposes. It is contemplated that the recliner assembly 18 of the present disclosure may be used as a single recliner on one side only of the vehicle seat assembly 10 or may include a pair of recliner assemblies 18 used on each side of the seat assembly 10. As will be described in detail below, the seat back 14 is pivotable between an upright position, as shown in FIG. 1, for supporting an occupant seated on the seat assembly 10, to a storage position, as shown in FIG. 2. As shown in FIG. 1, the recliner assembly 18 is illustrated such that the seat back 12 is in its upright position, or seated position. It is contemplated, that the in the upright position, the seat may be generally vertical or have a reclined seating angle from vertical.

In the storage position, a front surface 20 of the seat back 14 may be pivoted so that the seat back 14 positioned above and may rest on an upper surface 22 of the seat bottom 12. When the seat back 14 is in the storage position, a rear surface 24 of the seat back 14 may be a generally horizontal plane and can be used as a flat load floor for the storage of cargo thereon. The flat load floor of the seat assembly 10 can be used in cooperation with other seats and structures of the vehicle to create a large flat load floor in the vehicle.

The seat assembly 10 may include a latch mechanism 30. The latch mechanism 30 selectively latches the seat back 14 relative to the seat bottom 12 to prevent pivoting. For example the latch mechanism 30 is operable to maintain the seat back 14 in an upright position, and can be operated to release the seat back 14 from the seat bottom 12 so the seat back 14 can be moved or pivoted forwards towards a storage position. The latch mechanism 30 may also selectively latch the seat back 14 in the storage position. A handle 32 may be located on the side of the seat assembly 10 to manually actuate the latch mechanism 30. To move the seat back 14 to the storage position, the handle 32 is typically operated to release the latch mechanism 30 and permit the seat back 14 to pivot forward to the storage position.

To assist in pivoting the seat back 14 to the storage position, the seat assembly 10 may include a biasing member 34 connected between the seat bottom 12 and seat back 14 which biases the seat back 14 to the storage position. When the handle 32 is operated to release the latch mechanism 30, the spring 34 will automatically pivot the seat back 14 from the upright position to the storage position.

The biasing member 34 may be any suitable spring or biasing member which is operatively connected between the seat back 14 and seat bottom 12. In one embodiment the spring 34 biases the seat back 14 in a generally forward or clockwise direction, as shown in FIG. 2. In the embodiment illustrated, the spring 34 is a coiled spiral spring or a power spring, however any suitable biasing member is contemplated.

In some seat assemblies 10, the spring force generated by the spring 34 must be relatively high to overcome the weight of the seat back 14 and/or the frictional forces of the recliner assembly 18. Due to this large spring force and relatively fast motion of the seat back 14, the seat back 14 may experience bounce-back in the opposite direction when the forward movement of the seat back 14 is stopped. The seat back 14 may also experience bounce-back when the seat back 14 initially contacts the seat bottom 16 due to the springiness of the cushions of the seat back 14 and seat bottom 12. Although the relatively large spring force may be required to adequately move the seat back 14, this bounce-back may be undesirable by some consumers of passenger vehicles.

To prevent the seat back 14 from pivoting too forcefully and rapidly or experiencing bounce-back, the recliner assembly 18 may include at least one damper assembly 40. A cross-section of the damper assembly 40 is illustrated in FIGS. 3 and 4. The damper assembly 40 dampens the movement of the seat back 14, relative to the seat bottom 12 when the seat back 14 is moved from the upright position to the storage position. The damper assembly 40 dampens this motion by reducing the velocity or acceleration of the seat back 14 as it approaches the seat bottom 12.

Turning now to FIGS. 3 and 4, a cross-section of the damper assembly 40 is illustrated. The damper assembly 40 includes an outer ring 42 and an inner ring 44 disposed inside the outer ring 42. The damper assembly 40 also includes a plurality of rollers 46 which cooperate with the inner ring and outer ring to dampen movement of the seat back 14 as it is moved from the upright position to the storage position.

The inner ring 42 has an outer race 48 formed of an annular cam surface. In one embodiment, illustrated in FIGS. 3 and 4, the annular cam surface 48 includes a plurality of teeth 64 that extend towards an inner race 52 of the outer ring 42 which defines a plurality of recesses 54 between the outer ring 42 and the inner ring 44. The teeth 64 extend proximate the inner race 52 of the outer ring 42 to help maintain the outer ring 42 concentrically spaced from the inner ring 44. The annular cam surface 48 also includes a plurality of ramp portions 50. The ramp portions 50 may be defined between the plurality of teeth 64. Alternatively, the ramp portions 50 may define at least a portion of the teeth 64.

The inner ring 44 further includes an inner raceway 56. The inner race 56 of the inner ring 44 may be a splined surface to receive a corresponding fastener 58. In another embodiment, the inner raceway 56 may be a through opening with a surface to correspond with any suitable fastener 58 such as a threaded fastener or a bolt, for example.

The rollers 46 may be roller bearings or cylinders which are sized to cooperate between the inner ring 44 and the outer ring 42. In one embodiment, the inner ring 44 is formed of copper, however, the inner ring 44 may be formed of an suitable material. The rollers 46 may be formed of a material that is softer than the outer ring 42 and inner ring 44. In another embodiment, the rollers 46 are deformable between the inner ring 44 and outer ring 42 to dampen movement of the seat back 14.

As further illustrated in FIGS. 3 and 4, the rollers 46 are positioned in the recesses 54. Each recess 54 has an opening width which varies along the circumference of the outer race 48 of the inner ring 44. The width of the recess 54 is larger along a first end 60 and narrows along a second end 62 adjacent the ramp portion 50. The inner ring 44 and the outer ring 42 may rotate freely with respect to each other. It is contemplated that either the outer ring 42 or inner ring 44 may move while the other is held stationary. In another embodiment, both the outer ring 42 and inner ring 44 may be allowed to move.

FIG. 3 illustrates the damper assembly 40 where seat back 14 may be locked by the latch mechanism 30 in an upright seated position, like in FIG. 1, and the damper assembly 40 is in an un-dampened position. In the un-damped position, the rollers 46 are positioned adjacent the first end 60 of the recesses 54 so that the rollers 46 may freely rotate with little or no friction forces on the rollers 46 from the outer ring 42 and the inner ring 44. As the inner ring 44 and outer ring 42 rotate with respect to each other when the seat back 14 is moved in the direction X, the rollers 46 move from the first end 60 toward the second end 62 of the recesses 54 to engage the ramp portions 50 along the outer race 48 of the inner ring 44, as shown in the damped position in FIG. 4.

In one embodiment, the ramp portion 50 may extend along a portion of the outer race 48 of the inner ring 44. In another embodiment, the ramp portion 50 may extend the entire distance from the first end 60 to the second end 62 of the recess 54 to form a plurality of saw-tooth shaped teeth 64 along the outer race 48 of the inner ring 44.

The reduced width of the recesses 54 from the first end 60 to the second end 62 creates increased frictional forces on the rollers 46. The frictional forces between the rollers 46 and the inner ring 44 and the outer ring 42 acts as a dampening force to dampen movement of the seat back 14 as it is moved between an upright position and a storage position. Initial engagement occurs between rollers 46 and the ramp portion 50 when the seat back 12 is pivoted in the forward in the first direction.

The amount or time of dampening forces may be varied in a damper 40 by the gradient or slope of the ramp portions 50 as well as the length of the ramp portions 50. The dampening forces may also be impacted by the number of teeth 64 and consequently the number of recesses 54 formed along of the inner roller 44. In one embodiment, a fewer number of rollers 46 and a lower slope may have a slower (time) impact of damping. As such, the lower gradient of the ramp portion 50 and/or fewer rollers 46 may have a smoother damping function. As the angular degree of the ramp portion 50 increases, the amount of dampening force may also increase. In another embodiment, a greater number of rollers 46 and/or a higher gradient along the ramp portion 50 may create a faster (time) impact of damping. As such, greater number of rollers 46 or higher gradient along the ramp portion 50 may create a harder damping function. In an alternate embodiment, the diameter of the rollers 46 may also be increased to create higher dampening forces.

The damper assembly 40 also allows movement of the seat back 14 in a second counter clockwise direction in order to return the seat to the upright position. As the inner ring 44 and outer ring 42 rotate with respect to each other, the roller 46 moves from the second end 62 of the recess 54 towards the first end 60 of the recess 54 so that the roller 46 may freely rotate. In the un-damped position, as shown in FIG. 3, the seat back 14 can be pivoted back to an upright position from a storage position.

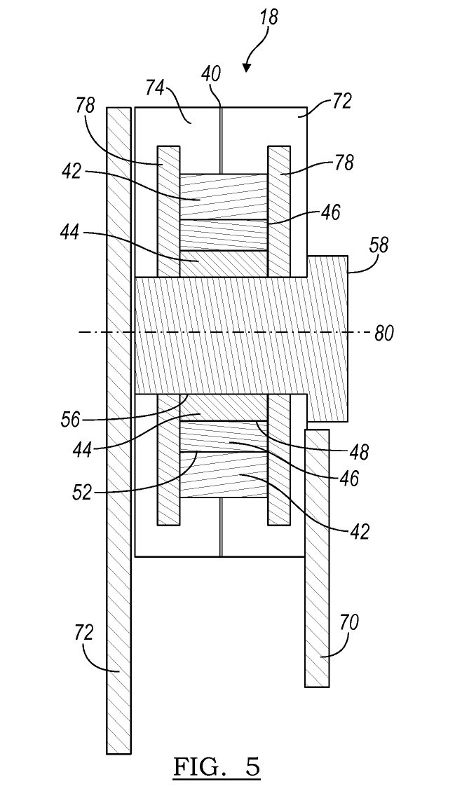

Turning now to FIG. 5, a cross-section view of the recliner assembly 18 and damper assembly 40 through section A-A is shown. The recliner assembly 18 includes a first frame member 70 adapted to these supported by the vehicle and a second frame member 72 adapted to support the seat back 14. The first frame member 70 may also support the seat bottom 12. The second frame member is pivotally attached to the first frame member 70 so that the seat back 14 is movable between an upright position and a storage position. The damper assembly 40 includes a pair of damper housing portions 74, 76.

The damper assembly 40 further includes a pair of sliding plates 78. The sliding plates 78 may be formed of a low friction material, such as polyoxymethylene (POM) material. The sliding plates 78 are located along the lateral sides of the outer ring 42 and inner ring 44 to facilitate rotation of the damper assembly 40, including the sliding of the rollers 46 with respect to the housings 74, 76.

The outer ring 42 is operatively mounted to one of the first and second frame members 70, 72. The inner ring 44 is operatively mounted to the other of the first and second frame members 70, 72. The first frame member is 70 is pivotally attached to the second frame member 72 along an axis 80. Likewise, the outer ring 42 is pivotally connected to the inner ring 44 along the axis 80.

The fastener 58 may connect the damper housing portions 74, 76 and the first frame member 70. The dampening force may be adjusted based on a clamping force in assembly of the fastener 58 to the first frame member 70 and second frame member 72. The clamping force by the fastener 58 may adjust the tolerance of the dampening force of the damper 40 in order to correspond to the tolerances of the spring 34. The damper 40 may be connected to the seat assembly by with a screw fastener any other mechanical binding technology such as welding or bonding, for example.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A recliner assembly for a vehicle seat, the recliner assembly comprising:
a first frame member adapted to be supported by a vehicle;
a second frame member adapted to support a seat back, the second frame member being pivotally attached to the first frame member and movable between an upright position wherein the seat back supports an occupant seated on the seat, and a storage position where the seat back is folded with respect to a seat bottom;
an outer ring mounted to one of the first and second frame members;
an inner ring disposed inside the outer ring and mounted to the other of the first and second frame members, the outer and inner rings collectively providing a plurality of recesses formed between the inner ring and the outer ring; and
a plurality of rollers disposed in the plurality of recesses, the rollers cooperating with the inner ring and the outer ring to dampen movement of the second frame in a first direction as the seat back is moved from the upright position to the storage position.

2. The recliner assembly of claim 1, wherein the outer ring comprises an inner raceway, and the inner ring comprises an outer annular cam surface to define the plurality of recesses between the outer ring and the inner ring.

3. The recliner assembly of claim 2, wherein the cam surface further comprises a plurality of ramp portions that extends proximate the inner raceway to maintain the outer ring concentrically spaced from the inner ring.

4. The recliner assembly of claim 3, wherein the rollers are formed of a material that is softer than the inner ring and outer ring such that the rollers deform as the rollers roll along the ramp portion of the cam surface thereby dampening movement of the second frame member in the first direction as the seat back is moved between the upright position and the storage position.

5. The recliner assembly of claim 2, wherein the inner ring further comprises an inner splined surface.

6. The recliner assembly of claim 1, wherein the outer ring is rotated with respect to the inner ring when the seat back is moved between the upright position and the storage position.

7. The recliner assembly of claim 1, wherein said recliner assembly further includes a spring member connected between the first frame member and the second frame member such that the spring member biases the seat back to the storage position.

8. The recliner assembly of claim 1, further comprising first and second plates respectively connected to said first and second frame members and mounted for sliding to lateral sides of inner ring and outer ring.

9. The recliner assembly of claim 8 wherein the first and second plates are formed of a low friction plastic.

10. The recliner assembly of claim 1, wherein the rollers are formed of a material that is softer than the inner and outer races, the rollers being deformable between the outer race and inner race to dampen movement of the seat back.

11. A vehicle seat comprising:
a seat bottom;
a seat back pivotally mounted relative to the seat bottom and movable between an upright position where the seat back is in a generally vertical position for supporting an occupant seated on the seat, and a storage position where the seat back is folded with respect to the seat bottom;
a damper operatively connected between the seat bottom and seat back the damper comprising:
an outer race;
an inner race, wherein at least one of the inner race and outer race comprise an annular cam-profile surface; and
a plurality of engaging members disposed between the inner race and outer race, to cooperate with the cam-profile surface and the other one of the inner race and outer race to dampen movement of the seat back during at least partial movement from the upright position to the storage position.

12. The vehicle seat of claim 11 further comprising a spring member connected between the seat back and the seat bottom that the spring member biases the seat back to the storage position.

13. The vehicle seat of claim 11, wherein the engaging members comprise roller-bearing cylinders.

14. The vehicle seat of claim 13, wherein the roller bearing cylinders are formed of a material that is softer than the inner and outer races, the roller bearing cylinders being deformable between the outer race and inner race to dampen movement of the seat back.

15. The vehicle seat of claim 11 wherein the cam-profile surface defines a plurality of recesses between the outer race and the inner race, one of the engaging members disposed in each of the recesses.

16. The vehicle seat of claim 11, wherein the cam-profile surface is defined along the inner race.

17. The vehicle seat of claim 11, wherein the cam-profile surface further comprises a ramp portion that extends between the inner race and the outer race.

18. The vehicle seat of claim 11, further comprising first and second plates mounted to lateral sides of inner ring and outer ring for sliding.

19. The vehicle of claim 18 wherein the first and second plates are formed of a low friction plastic.

20. A damper assembly comprising:
an outer ring adapted to be mounted to one of a seat bottom and a seat back;
an inner ring disposed inside the outer ring, the inner ring being adapted to be mounted to the other of the seat bottom and the seat back, the inner ring cooperating with the outer ring to collectively provide a plurality of recesses formed between the inner ring and the outer ring; and
a plurality of rollers disposed in the plurality of recesses, the rollers cooperating with the inner ring and the outer ring to dampen movement of the seat back in a first direction from a upright position to a storage position, wherein the damper allows to movement of the seat back in a second direction to return to the seat back to the upright position.
